(19) United States
(12) Patent Application Publication
(10) Pub. No.: US 2026/0214284 A1
(43) Pub. Date: Jul. 23, 2026

(54) LIVE STREAM SWITCHING METHOD, ELECTRONIC DEVICE AND STORAGE MEDIUM

(71) Applicant: Beijing Baidu Netcom Science Technology Co., Ltd., Beijing (CN)

(72) Inventors: Tengfei SHAN, Beijing (CN); Chenfei WANG, Beijing (CN)

(21) Appl. No.: 19/569,324

(22) Filed: Mar. 17, 2026

(30) Foreign Application Priority Data
Jun. 20, 2025 (CN) 202510837329.1

(51) Int. Cl. H04N 21/238; H04N 21/2187; H04N 21/239; H04N 21/242; H04N 21/2665; H04N 21/8547

(52) U.S. Cl. CPC H04N 21/238; H04N 21/2187; H04N 21/2393; H04N 21/242; H04N 21/2665; H04N 21/8547

(57) ABSTRACT

A live stream switching method and an electronic device are provided. The method includes: receiving a stream switching request sent by a client, where the stream switching request includes a target resolution; pulling an original live stream from a first source and a target live stream corresponding to the target resolution from a second source, and transmitting the original live stream to the client; performing timestamp alignment between the original live stream and the target live stream; and in response to determining that alignment is successful, ceasing transmission of the original live stream and transmitting the target live stream to the client.

### CROSS-REFERENCE TO RELATED APPLICATIONS

This application claims the priority from Chinese Patent Application No. 202510837329.1, filed on Jun. 20, 2025, the entire disclosure of which is hereby incorporated by reference.

### TECHNICAL FIELD

The present disclosure relates to the field of artificial intelligence and cloud computing technology, and in particular, to the field of video cloud and audio-video live streaming technology.

### BACKGROUND

In live streaming scenarios, streamers use their own devices to push live streams to live streaming services. Users use their own devices to download and play live streams of corresponding streamers. Since there is only one streamer, the data bit rate of the pushed stream is determined by the streamer. However, different users have vastly different device types (such as high-end devices, mid-range devices, low-end devices, etc.) and network types (such as Wi-Fi, mobile data, etc.), and users'network conditions also change in real time (such as walking into an elevator). To accommodate different user needs, live streaming services typically transcode the stream pushed by the streamer into live streams of different resolutions, so that users can pull corresponding live streams according to their device types and network conditions.

Live stream switching can be used to pull high-resolution live streams when network conditions improve, and to pull low-resolution live streams when network conditions deteriorate.

### SUMMARY

Embodiments of the present disclosure propose a live stream switching method, a device, and a storage medium.

In a first aspect, an embodiment of the present disclosure provides a live stream switching method, including: receiving a stream switching request from a client, where the switching request includes a target resolution; pulling an original live stream from a first source and a target live stream corresponding to the target resolution from a second source, and transmitting the original live stream to the client; performing timestamp alignment between the original live stream and the target live stream; and in response to determining that alignment is successful, ceasing transmission of the original live stream and transmitting the target live stream to the client.

In a second aspect, an embodiment of the present disclosure provides an electronic device, including: at least one processor; and a memory communicatively connected to the at least one processor; where the memory stores instructions executable by the at least one processor, and the instructions, when executed by the at least one processor, cause the at least one processor to perform the method as described in the first aspect.

In a third aspect, an embodiment of the present disclosure provides a non-transitory computer-readable storage medium storing computer instructions, where the computer instructions are used to cause a computer to perform the method as described in the first aspect.

The key or important features of the embodiments of the present disclosure are not intended to limit the scope of the present disclosure. Other features of the present disclosure will become readily apparent from the following description.

### BRIEF DESCRIPTION OF THE DRAWINGS

Other features, objects, and advantages of the present disclosure will become more apparent through reading the detailed description of the non-limiting embodiments with reference to the following drawings. The drawings are used to better understand the present solution and do not constitute a limitation on the present disclosure.

FIG. 1 is a flowchart of an embodiment of a live stream switching method according to the present disclosure;

FIG. 2 is a flowchart of another embodiment of a live stream switching method according to the present disclosure;

FIG. 3 is a flowchart of an application scenario in which a live stream switching method of an embodiment of the present disclosure may be implemented;

FIG. 4 is an effect diagram of live stream switching when a target live stream is slower than an original live stream;

FIG. 5 is an effect diagram of live stream switching when a target live stream is faster than an original live stream;

FIG. 6 is a schematic structural diagram of an embodiment of a live stream switching apparatus according to the present disclosure; and

FIG. 7 is a block diagram of an electronic device for implementing a live stream switching method of an embodiment of the present disclosure.

### DETAILED DESCRIPTION OF EMBODIMENTS

The following describes exemplary embodiments of the present disclosure with reference to the accompanying drawings, including various details of the embodiments to facilitate understanding, which should be regarded as merely exemplary. Therefore, those of ordinary skill in the art should recognize that various changes and modifications can be made to the embodiments described herein without departing from the scope and spirit of the present disclosure. Similarly, for clarity and conciseness, descriptions of well-known functions and structures are omitted from the following description.

It should be noted that, in the absence of conflict, the embodiments in the present disclosure and features in the embodiments may be combined with each other. The present disclosure will be described in detail below with reference to the drawings and embodiments.

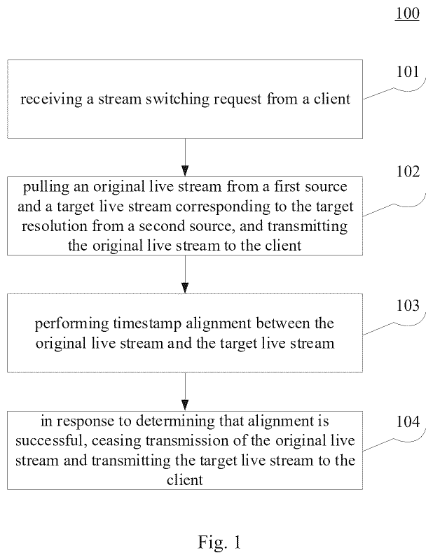

FIG. 1 illustrates a flow 100 of an embodiment of a live stream switching method according to the present disclosure. The live stream switching method includes the following steps.

Step 101: receiving a stream switching request from a client.

In this embodiment, an execution entity of the live stream switching method may receive a stream switching request from a client.

The execution entity of the live stream switching method is typically a server. The server may be hardware or software. When the server is hardware, it may be implemented as a distributed server cluster including multiple servers, or as a single server. When the server is software, it may be implemented as multiple software pieces or software modules (for example, for providing distributed services), or as a single software piece or software module. No specific limitation is made thereto.

In a live streaming scenario, a streamer may use his/her own device to push a live stream to a live streaming service. The live streaming service may transcode the stream pushed by the streamer into live streams of different resolutions. A user may pull a live stream of a corresponding resolution for playback and viewing according to a client type and network conditions. During the user's viewing of the live stream, if the client perceives a change in network conditions, the client may determine a target resolution according to the changed network conditions and send a stream switching request.

The stream switching request may be a switching signal sent by the client, indicating the target resolution. For example, the stream switching request may be a packet in a specific format sent through a UDP (User Datagram Protocol) or TCP (Transmission Control Protocol) connection. The packet may carry text information, and the text information may carry the target resolution.

When network conditions deteriorate, to ensure smooth viewing for the user, the target resolution is lower than the resolution of the original live stream. When network conditions improve, to enhance the user viewing experience, the target resolution is higher than the resolution of the original live stream.

Step 102: pulling an original live stream from a first source and a target live stream corresponding to the target resolution from a second source, and transmitting the original live stream to the client.

In this embodiment, after receiving the stream switching request, the execution entity may pull an original live stream from the first source and a target live stream corresponding to the target resolution from the second source, and transmit the original live stream to the client.

When the live streaming service transcodes the stream pushed by the streamer into live streams of different resolutions, the live streaming service may cache these live streams. Therefore, when pulling the target live stream, the user first pulls the cached target live stream. After a period of time, when the cached target live stream has been fully pulled, the user then pulls the target live stream that is being transcoded in real time by the live streaming service. Since the speed of the live stream needs to be determined based on the real-time live stream, it is necessary to simultaneously pull the original live stream and the target live stream from the first and the second sources for a period of time to pass the stage of pulling the cached target live stream and enter the stage of pulling the real-time target live stream, so as to compare the speeds of the original live stream and the target live stream.

In some embodiments, pulling an original live stream and a target live stream from the first and the second sources until at least one of the following conditions is met ensures entry into the stage of pulling the real-time target live stream.

First, simultaneously pulling an original live stream and a target live stream from sources until a preset duration threshold is exceeded. The preset duration threshold may be an empirical value, such as 2 seconds. Generally, 2 seconds is sufficient to fully pull the cached target live stream.

Second, simultaneously pulling an original live stream and a target live stream from the first and the second sources until a ratio of an interval between playback timestamps of two consecutive frames of the target live stream to an interval between reception timestamps of the two consecutive frames is less than a preset ratio threshold. The preset ratio threshold may be an empirical value, such as 1.5.

Step 103: performing timestamp alignment between the original live stream and the target live stream.

In this embodiment, the execution entity may perform timestamp alignment between the original live stream and the target live stream, thereby aligning identical video frames in the original live stream and the target live stream to the same position.

Since live streams of different resolutions are re-encoded by a transcoding service based on the stream pushed by the streamer, these live streams have certain delays relative to the stream pushed by the streamer. When switching from a live stream with a lower delay to a live stream with a higher delay, or from a live stream with a higher delay to a live stream with a lower delay, the original live stream and the target live stream may be aligned through proper delay handling.

Step 104: in response to determining that alignment is successful, ceasing transmission of the original live stream and transmitting the target live stream to the client.

In this embodiment, when timestamp alignment between the original live stream and the target live stream is successful, transmission of the original live stream may be ceased and the target live stream may be transmitted to the client, thereby achieving smooth switching from the original live stream to the target live stream without user perception, so that the live stream viewed by the user is continuous and smooth.

The embodiment of the present disclosure provides a live stream switching method. By performing timestamp alignment between the pulled original live stream and the target live stream, an appropriate timing can be found to smoothly switch from the original live stream to the target live stream, so that the live stream viewed by the user is continuous and smooth without causing client stuttering. Moreover, the user is unaware of the switching operation, which can enhance the user viewing experience.

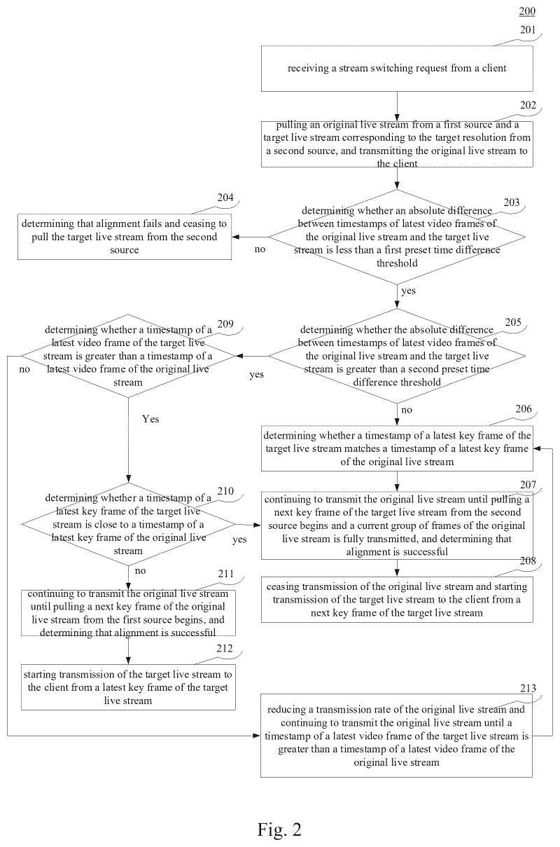

With continued reference to FIG. 2, a flow 200 of another embodiment of a live stream switching method according to the present disclosure is shown. The live stream switching method includes the following steps.

Step 201: receiving a stream switching request from a client.

Step 202: pulling an original live stream from a first source and a target live stream corresponding to the target resolution from a second source, and transmitting the original live stream to the client.

In this embodiment, specific operations of steps 201-202 have been described in detail in steps 101-102 of the embodiment shown in FIG. 1, and are not repeated here.

Step 203: determining whether an absolute difference between timestamps of latest video frames of the original live stream and the target live stream is less than a first preset time difference threshold.

In this embodiment, the execution entity of the live stream switching method may determine whether an absolute difference between timestamps of latest video frames of the original live stream and the target live stream is less than a first preset time difference threshold. If the absolute difference is not less than the first preset time difference threshold, step 204 is executed; if the absolute difference is less than the first preset time difference threshold, step 205 is executed.

Based on timestamps of latest video frames of the two pulled live streams, the synchronization status of the two live streams may be determined. If the absolute difference between timestamps of latest video frames of the two live streams is not less than the first preset time difference threshold, it indicates that the two live streams differ significantly and an abnormal situation may have occurred. If the absolute difference between timestamps of latest video frames of the two live streams is less than the first preset time difference threshold, it indicates that the two live streams are basically synchronized.

Step 204: determining that alignment fails and ceasing to pull the target live stream from the second source.

In this embodiment, if the absolute difference between timestamps of latest video frames of the original live stream and the target live stream is not less than the first preset time difference threshold, it indicates that the original live stream and the target live stream differ significantly and an abnormal situation may have occurred. The execution entity may determine that alignment fails and cease to pull the target live stream from the second source. In this case, the original live stream continues to be transmitted to the client.

Step 205: determining whether the absolute difference between timestamps of latest video frames of the original live stream and the target live stream is greater than a second preset time difference threshold.

In this embodiment, if the absolute difference between timestamps of latest video frames of the original live stream and the target live stream is less than the first preset time difference threshold, it indicates that the original live stream and the target live stream are basically synchronized. The execution entity may determine whether the absolute difference between timestamps of latest video frames of the original live stream and the target live stream is greater than a second preset time difference threshold. If the absolute difference is not greater than the second preset time difference threshold, step 206 is executed; if the absolute difference is greater than the second preset time difference threshold, step 209 is executed. The second preset time difference threshold is less than the first preset time difference threshold.

Step 206: determining whether a timestamp of a latest key frame of the target live stream matches a timestamp of a latest key frame of the original live stream.

In this embodiment, if the absolute difference between timestamps of latest video frames of the original live stream and the target live stream is not greater than the second preset time difference threshold, the execution entity may determine whether a timestamp of a latest key frame of the target live stream matches (e.g., the same as) a timestamp of a latest key frame of the original live stream. If the timestamp of the latest key frame of the target live stream matches the timestamp of the latest key frame of the original live stream, it indicates that the latest key frame of the original live stream is aligned with the latest key frame of the target live stream, and step 207 is executed.

A live stream is composed of groups of video frames. A group of video frames typically consists of three types of frames: key frames, predictive coded frames, and bi-directionally predictive coded frames. A key frame is an independently encoded frame that does not rely on other frames for decoding. A key frame contains complete image information and can be decoded alone into a complete picture. Each group of video frames starts with a key frame. A predictive coded frame is coded by using previous key frames or previous predictive coded frames through motion prediction. A predictive coded frame records changes relative to reference frames. A bi-directionally predictive coded frame is coded by using preceding and following key frames or preceding and following predictive coded frames through bi-directional predictive encoding. A bi-directionally predictive coded frame provides the highest compression ratio but requires more computational resources for decoding.

Step 207: continuing to transmit the original live stream until pulling a next key frame of the target live stream from the second source begins and a current group of frames of the original live stream is fully transmitted, and determining that alignment is successful.

In this embodiment, if the timestamp of the latest key frame of the target live stream matches the timestamp of the latest key frame of the original live stream, the execution entity may continue to transmit the original live stream until pulling a next key frame of the target live stream from the second source begins and a current group of frames of the original live stream is fully transmitted, and determine that alignment is successful, and step 208 is executed.

In the case that the latest key frame of the original live stream is aligned with the latest key frame of the target live stream, when pulling a next key frame of the target live stream from the second source begins, the current group of frames of the original live stream is also fully transmitted.

Step 208: ceasing transmission of the original live stream and starting transmission of the target live stream to the client from a next key frame of the target live stream.

In this embodiment, when alignment is successful, the execution entity may cease transmission of the original live stream and start transmission of the target live stream to the client from a next key frame of the target live stream.

It should be noted that since a key frame is the start of a group of video frames of a live stream, switching needs to start from the key frame of the group of video frames.

Step 209: determining whether a timestamp of a latest video frame of the target live stream is greater than a timestamp of a latest video frame of the original live stream.

In this embodiment, if the absolute difference between timestamps of latest video frames of the original live stream and the target live stream is greater than the second preset time difference threshold, the execution entity may determine whether a timestamp of a latest video frame of the target live stream is greater than a timestamp of a latest video frame of the original live stream. If the timestamp of the latest video frame of the target live stream is greater than the timestamp of the latest video frame of the original live stream, it indicates that the speed of the target live stream is greater than the speed of the original live stream, and step 210 is executed. If the timestamp of the latest video frame of the target live stream is not greater than the timestamp of the latest video frame of the original live stream, it indicates that the speed of the target live stream is not greater than the speed of the original live stream, and step 213 is executed.

Step 210: determining whether a timestamp of a latest key frame of the target live stream is close to a timestamp of a latest key frame of the original live stream.

In this embodiment, if the timestamp of the latest video frame of the target live stream is greater than the timestamp of the latest video frame of the original live stream, the execution entity may determine whether a timestamp of a latest key frame of the target live stream is close to a timestamp of a latest key frame of the original live stream. If the timestamp of the latest key frame of the target live stream is close to the timestamp of the latest key frame of the original live stream, it indicates that the length by which the target live stream is ahead of the original live stream does not exceed one group of video frames, and steps 207-208 are executed. If the timestamp of the latest key frame of the target live stream is not close to the timestamp of the latest key frame of the original live stream, it indicates that the length by which the target live stream is ahead of the original live stream exceeds one group of video frames, and step 211 is executed.

If the speed of the target live stream is greater than the speed of the original live stream, but the length by which the target live stream is ahead does not exceed one group of video frames, then the next key frame pulled from the second source is a key frame of the target live stream. This key frame and subsequent frames of the target live stream are cached. When pulling a next key frame of the original live stream from the first source begins, transmission of the target live stream is started directly from this key frame of the target live stream.

Step 211: continuing to transmit the original live stream until pulling a next key frame of the original live stream from the first source begins, and determining that alignment is successful.

In this embodiment, if the timestamp of the latest key frame of the target live stream is not close to the timestamp of the latest key frame of the original live stream, the execution entity may continue to transmit the original live stream until pulling a next key frame of the original live stream from the first source begins, and determine that alignment is successful, and step 212 is executed.

Step 212: starting transmission of the target live stream to the client from a latest key frame of the target live stream.

In this embodiment, when alignment is successful, the execution entity may start transmission of the target live stream to the client from the latest key frame of the target live stream.

If the speed of the target live stream is greater than the speed of the original live stream, but the length by which the target live stream is ahead exceeds one group of video frames, the latest key frame and subsequent frames of the target live stream are cached. When the current group of frames of the original live stream is fully transmitted, transmission is started directly from the latest key frame of the target live stream.

Step 213: reducing a transmission rate of the original live stream and continuing to transmit the original live stream until a timestamp of a latest video frame of the target live stream is greater than a timestamp of a latest video frame of the original live stream.

In this embodiment, if the timestamp of the latest video frame of the target live stream is not greater than the timestamp of the latest video frame of the original live stream, the execution entity may reduce a transmission rate of the original live stream and continue to transmit the original live stream until a timestamp of a latest video frame of the target live stream is greater than a timestamp of a latest video frame of the original live stream, and steps 206-208 are executed.

If the speed of the target live stream is smaller than the speed of the original live stream, the original live stream needs to be transmitted at a reduced rate to wait for the target live stream to catch up.

The embodiment of the present disclosure provides a live stream switching method. When the original live stream and the target live stream are basically synchronized, timestamp alignment is performed for various situations, expanding the applicable scope of imperceptible switching.

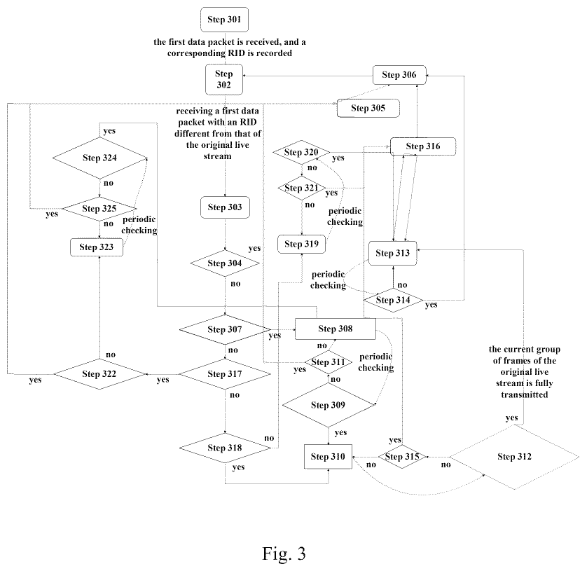

FIG. 3 illustrates a flowchart of an application scenario in which a live stream switching method of an embodiment of the present disclosure may be implemented.

Step 301: INIT.

In a live streaming scenario, INIT is used to initialize the state. When the first data packet is received, a corresponding RID (Record ID) is recorded. The INIT method is a special constructor that is automatically called when creating a new instance of a class. The main function of the INIT method is to initialize the state of an object, ensuring that each object is properly set up before use. RID can be used to uniquely identify the original live stream.

Step 302: NORMAL_SENDING.

NORMAL_SENDING is normal transmission of the original live stream, indicating that no switching behavior has occurred. This continues until a data packet with an RID different from that of the original live stream is received, indicating that the client has initiated a switching requirement.

Step 303: BURST_WAITING.

BURST_WAITING is a state in which, after receiving a switching requirement from the client and starting to pull the target live stream from the second source, the current state is maintained for a period of time to pass the stage of pulling the cached target live stream and enter the stage of pulling the real-time target live stream. Only then can the speed of the target live stream and the original live stream be compared, and the degree of difference is determined. During this stage, the original live stream is transmitted normally, and the target live stream is cached normally.

Step 304: determining whether the two live streams differ significantly or have abnormal status values. If yes, step 305 is executed; if no, step 307 is executed.

Step 305: notifying a listener to abandon switching, deleting the target live stream, and removing states and attributes related to the target live stream.

If the timestamps of latest video frames of the two live streams differ significantly, it indicates that some abnormality has occurred. The switching behavior is stopped, pulling of the target live stream from the second source is ceased, and the original live stream continues to be transmitted.

Step 306: notifying the listener that the switching process has ended, and continuing to execute step 302.

Step 307: determining whether an absolute value of a difference between timestamps of latest received video frames of the two live streams is less than a threshold. If yes, step 308 is executed; if no, step 317 is executed.

If the timestamps of latest video frames of the two live streams differ slightly, it indicates that the two live streams are basically synchronized.

Step 308: WAIT_FOR_LAST_SEND_KEYFRAME_EQUAL.

WAIT_FOR_LAST_SEND_KEYFRAME_EQUAL is waiting for the timestamp of the latest received key frame of the target live stream to match the timestamp of the latest received key frame of the original live stream. During this period, the original live stream is transmitted at 1.0× speed.

Step 309: determining whether timestamps of latest received key frames of the two live streams are the same. If yes, step 310 is executed; if no, step 311 is executed.

Step 310: NEXT_KEY_MUST_SWITCH, and step 312 is executed.

NEXT_KEY_MUST_SWITCH is waiting for the next key frame of the target live stream to arrive and the current group of frames of the original live stream to be fully transmitted, then starting transmission from the next key frame of the target live stream.

Step 311: determining whether a timeout has occurred. If yes, step 305 is executed; if no, step 308 is executed.

Step 312: determining whether the next key frame of the target live stream is received after the NEXT_KEY_MUST_SWITCH state is entered and whether the next key frame of the original live stream is received after the NEXT_KEY_MUST_SWITCH state is entered. If yes, the current group of frames of the original live stream is fully transmitted and step 313 is executed; if no, step 315 is executed.

Step 313: ACCELERATE_NEW_SYNCING, and step 314 is executed.

ACCELERATE_NEW_SYNCING is transmitting data of the target live stream, and if there is a cache of the target live stream, transmitting at an appropriately accelerated rate. During this period, the target live stream is transmitted at 1.3× speed.

Step 314: determining whether the cache of the target live stream is exhausted. If yes, step 306 is executed; if no, step 313 is executed.

Step 315: determining whether a timeout occurs. If yes, step 316 is executed; if no, step 310 is executed.

Step 316: notifying the listener to switch the RID of the target live stream, deleting the original live stream, updating attributes related to the stream name, and executing step 306.

Step 317: determining whether the timestamp of the latest received video frame of the original live stream is greater than the timestamp of the latest received video frame of the target live stream. If no, it indicates that the target live stream is faster than the original live stream, and step 318 is executed. If yes, it indicates that the original live stream is faster than the target live stream, and step 322 is executed.

Step 318: determining whether timestamps of latest received key frames of the two live streams are close. If yes, it indicates that the length by which the target live stream is ahead of the original live stream does not exceed one group of video frames, and step 310 is executed. If no, it indicates that the length by which the target live stream is ahead of the original live stream exceeds one group of video frames, and step 319 is executed.

Step 319: CACHE_NEW_SYNCING.

CACHE_NEW_SYNCING is caching data of the target live stream.

Step 320: determining whether a new key frame of the original live stream is received. If yes, step 313 is executed; if no, step 321 is executed.

Step 321: determining whether a timeout occurs. If yes, step 316 is executed; if no, step 319 is executed.

Step 322: estimating whether the time for slowly transmitting the original live stream to complete switching conditions exceeds a limit. If yes, step 305 is executed; if no, step 323 is executed.

Step 323: SLOW_OLD_SYNCING.

SLOW_OLD_SYNCING is slowly transmitting data of the original live stream. During this period, the original live stream is transmitted at 0.75× speed.

Step 324: determining whether the timestamp of the latest received video frame of the target live stream is greater than the timestamp of the latest received video frame of the original live stream. If yes, step 308 is executed; if no, step 325 is executed.

Step 325: determining whether a timeout occurs or whether an abnormality in pulling the target live stream from the second source is discovered. If yes, step 305 is executed; if no, step 323 is executed.

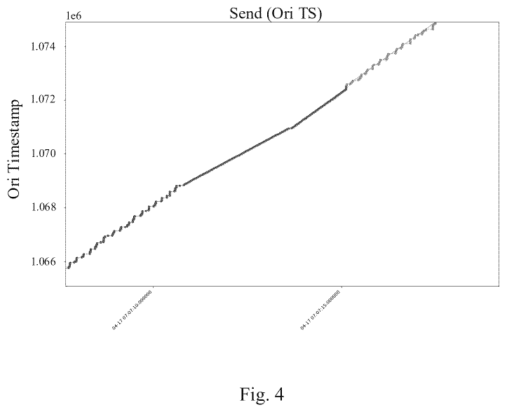

FIG. 4 illustrates an effect diagram of live stream switching when a target live stream is slower than an original live stream. As shown in FIG. 4, the horizontal axis of the coordinate system is the reception timestamp of the live stream, and the vertical axis is the playback timestamp of the live stream. The original live stream first undergoes a certain rate reduction until it synchronizes with the target live stream. Then, the original live stream resumes normal speed transmission until the target live stream directly continues.

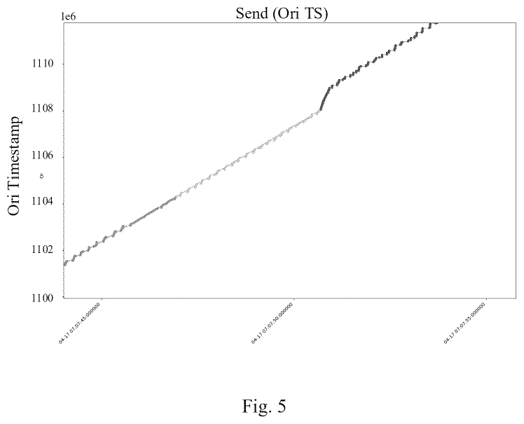

FIG. 5 illustrates an effect diagram of live stream switching when a target live stream is faster than an original live stream. As shown in FIG. 5, the horizontal axis of the coordinate system is the reception timestamp of the live stream, and the vertical axis is the playback timestamp of the live stream. After transmission of the original live stream ends, transmission of the target live stream is started from the continuation point. Because the target live stream is fast, there is already some cache from the continuation point. This portion of cache is transmitted at an accelerated rate for a period of time until exhausted, and then the target live stream resumes normal speed transmission.

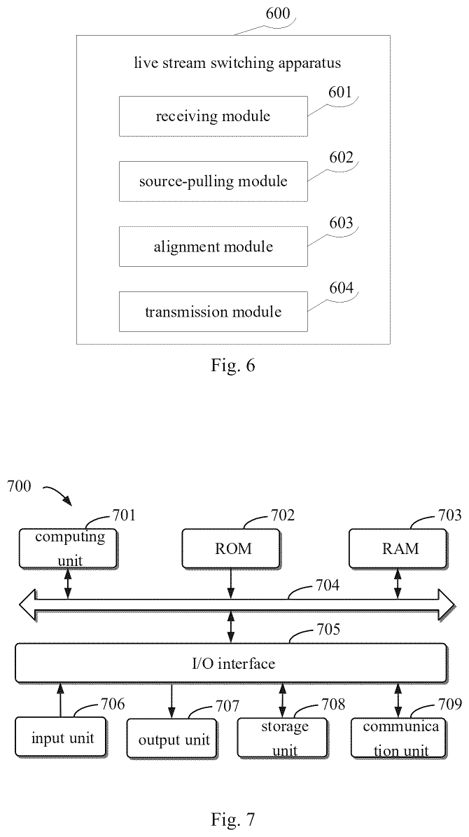

With further reference to FIG. 6, as an implementation of the methods shown in the above figures, the present disclosure provides an embodiment of a live stream switching apparatus, which corresponds to the method embodiment shown in FIG. 1, and can be specifically applied to various electronic devices.

As shown in FIG. 6, a live stream switching apparatus 600 of this embodiment may include: a receiving module 601, a source-pulling module 602, an alignment module 603, and a transmission module 604. The receiving module 601 is configured to receive a stream switching request from a client, where the switching request includes a target resolution. The source-pulling module 602 is configured to pull an original live stream from a first source and a target live stream corresponding to the target resolution from a second source, and transmit the original live stream to the client. The alignment module 603 is configured to perform timestamp alignment between the original live stream and the target live stream. The transmission module 604 is configured to, in response to determining that alignment is successful, cease transmission of the original live stream and transmit the target live stream to the client.

In this embodiment, specific processing of the receiving module 601, the source-pulling module 602, the alignment module 603, and the transmission module 604 in the live stream switching apparatus 600 and their technical effects may be referred to the relevant descriptions of steps 101-104 in the corresponding embodiment of FIG. 1, and are not repeated here.

In some optional implementations of this embodiment, the source-pulling module 602 is further configured to: pull an original live stream and a target live stream from the first and the second sources until a preset duration threshold is exceeded, and/or until a ratio of an interval between playback timestamps of two consecutive frames of the target live stream to an interval between reception timestamps of the two consecutive frames is less than a preset ratio threshold.

In some optional implementations of this embodiment, the apparatus further includes a stopping module configured to, in response to an absolute difference between timestamps of latest video frames of the original live stream and the target live stream being not less than a first preset time difference threshold, determine that alignment fails and cease to pull the target live stream from the second source.

In some optional implementations of this embodiment, the alignment module 603 is further configured to: in response to an absolute difference between timestamps of latest video frames of the original live stream and the target live stream being not greater than a second preset time difference threshold and a timestamp of a latest key frame of the target live stream matching a timestamp of a latest key frame of the original live stream, continue to transmit the original live stream until pulling a next key frame of the target live stream from the second source begins and a current group of frames of the original live stream is fully transmitted, and determine that alignment is successful. The transmission module 604 is further configured to: start transmission of the target live stream to the client from a next key frame of the target live stream.

In some optional implementations of this embodiment, the alignment module 603 is further configured to: in response to an absolute difference between timestamps of latest video frames of the original live stream and the target live stream being less than a first preset time difference threshold but greater than a second preset time difference threshold, a timestamp of a latest video frame of the target live stream being greater than a timestamp of a latest video frame of the original live stream, and a timestamp of a latest key frame of the target live stream being close to a timestamp of a latest key frame of the original live stream, continue to transmit the original live stream until pulling a next key frame of the target live stream from the second source begins and a current group of frames of the original live stream is fully transmitted, and determine that alignment is successful. The transmission module 604 is further configured to: start transmission of the target live stream to the client from a next key frame of the target live stream.

In some optional implementations of this embodiment, the alignment module 603 is further configured to: in response to an absolute difference between timestamps of latest video frames of the original live stream and the target live stream being less than a first preset time difference threshold but greater than a second preset time difference threshold, a timestamp of a latest video frame of the target live stream being greater than a timestamp of a latest video frame of the original live stream, and a timestamp of a latest key frame of the target live stream not being close to a timestamp of a latest key frame of the original live stream, continue to transmit the original live stream until pulling a next key frame of the original live stream from the first source begins, and determine that alignment is successful. The transmission module 604 is further configured to: start transmission of the target live stream to the client from a latest key frame of the target live stream.

In some optional implementations of this embodiment, the alignment module 603 is further configured to: in response to an absolute difference between timestamps of latest video frames of the original live stream and the target live stream being less than a first preset time difference threshold but greater than a second preset time difference threshold, and a timestamp of a latest video frame of the target live stream not being greater than a timestamp of a latest video frame of the original live stream, reduce a transmission rate of the original live stream and continue to transmit the original live stream until a timestamp of a latest video frame of the target live stream is greater than a timestamp of a latest video frame of the original live stream and a timestamp of a latest key frame of the target live stream matches a timestamp of a latest key frame of the original live stream, then continue to transmit the original live stream until pulling a next key frame of the target live stream from the second source begins and a current group of frames of the original live stream is fully transmitted, and determine that alignment is successful. The transmission module 604 is further configured to: start transmission of the target live stream to the client from a next key frame of the target live stream.

In the technical solution of the present disclosure, the collection, storage, and use of user personal information involved all comply with the provisions of relevant laws and regulations and do not violate public order and good customs.

According to embodiments of the present disclosure, the present disclosure also provides an electronic device, a readable storage medium, and a computer program product.

FIG. 7 illustrates a schematic block diagram of an example electronic device 700 that may be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital assistants, cellular telephones, smartphones, wearable devices, and other similar computing devices. The components shown here, their connections and relationships, and their functions are merely examples and are not intended to limit the implementation of the present disclosure described herein and/or claimed.

As shown in FIG. 7, device 700 includes a computing unit 701, which may execute various appropriate actions and processes according to a computer program stored in a read-only memory (ROM) 702 or a computer program loaded from a storage unit 708 into a random access memory (RAM) 703. In RAM 703, various programs and data required for operation of device 700 can also be stored. Computing unit 701, ROM 702, and RAM 703 are connected to each other through a bus 704. An input/output (I/O) interface 705 is also connected to bus 704.

Multiple components in device 700 are connected to I/O interface 705, including: an input unit 706, such as a keyboard, mouse, etc.; an output unit 707, such as various types of displays, speakers, etc.; a storage unit 708, such as a magnetic disk, optical disk, etc.; and a communication unit 709, such as a network card, modem, wireless communication transceiver, etc. Communication unit 709 allows device 700 to exchange information/data with other devices through a computer network such as the Internet and/or various telecommunications networks.

Computing unit 701 may be various general and/or dedicated processing components with processing and computing capabilities. Some examples of computing unit 701 include but are not limited to a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. Computing unit 701 executes the various methods and processes described above, such as the live stream switching method. For example, in some embodiments, the live stream switching method can be implemented as a computer software program tangibly contained in a machine-readable medium, such as storage unit 708. In some embodiments, part or all of the computer program can be loaded and/or installed onto device 700 via ROM 702 and/or communication unit 709. When the computer program is loaded into RAM 703 and executed by computing unit 701, one or more steps of the live stream switching method described above can be executed. Alternatively, in other embodiments, computing unit 701 can be configured to execute the live stream switching method by any other suitable means (for example, by means of firmware).

Various implementations of the systems and technologies described herein above may be implemented in digital electronic circuit systems, integrated circuit systems, field programmable gate arrays (FPGA), application specific integrated circuits (ASIC), application specific standard products (ASSP), systems on a chip (SOC), complex programmable logic devices (CPLD), computer hardware, firmware, software, and/or combinations thereof. These various implementations may include: being implemented in one or more computer programs that may be executed and/or interpreted on a programmable system including at least one programmable processor, which may be a dedicated or general-purpose programmable processor that may receive data and instructions from a storage system, at least one input device, and at least one output device, and transmit data and instructions to the storage system, the at least one input device, and the at least one output device.

Program code for implementing the method of the present disclosure may be written in any combination of one or more programming languages. These program codes may be provided to a general-purpose computer, a dedicated computer, or a processor or controller of other programmable data processing devices, such that when the program codes are executed by the processor or controller, the functions/operations specified in the flowcharts and/or block diagrams are implemented. The program code may be executed entirely on a machine, partly on a machine, partly on a machine and partly on a remote machine as a stand-alone software package, or entirely on a remote machine or server.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any suitable combination of the above. More specific examples of machine-readable storage media may include electrical connections based on one or more wires, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination of the above.

To provide interaction with a user, the systems and technologies described herein may be implemented on a computer having: a display device (for example, a CRT (cathode ray tube) or LCD (liquid crystal display) monitor) for displaying information to the user; and a keyboard and a pointing device (for example, a mouse or trackball) through which the user can provide input to the computer. Other types of devices may also be used to provide interaction with the user; for example, feedback provided to the user may be any form of sensory feedback (for example, visual feedback, auditory feedback, or tactile feedback); and input from the user may be received in any form, including acoustic input, voice input, or tactile input.

The systems and technologies described herein can be implemented in a computing system including back-end components (for example, as a data server), or a computing system including middleware components (for example, an application server), or a computing system including front-end components (for example, a user computer with a graphical user interface or web browser through which the user can interact with the implementation of the systems and technologies described herein), or any combination of such back-end components, middleware components, or front-end components. The components of the system can be interconnected by any form or medium of digital data communication (for example, a communication network). Examples of communication networks include: a local area network (LAN), a wide area network (WAN), and the Internet.

A computer system may include a client and a server. The client and server are generally remote from each other and typically interact through a communication network. The relationship of client and server is generated by computer programs running on respective computers and having a client-server relationship with each other. The server may be a cloud server, a server of a distributed system, or a server combined with blockchain.

It should be understood that the steps of reordering, adding or deleting may be performed using the various forms shown above. For example, the steps described in the present disclosure may be performed in parallel or sequentially or in a different order, so long as the desired results of the technical solution disclosed in the present disclosure can be realized, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A live stream switching method, comprising:
receiving a stream switching request from a client, wherein the switching request includes a target resolution;
pulling an original live stream from a first source and a target live stream corresponding to the target resolution from a second source, and transmitting the original live stream to the client;
performing timestamp alignment between the original live stream and the target live stream; and
in response to determining that the alignment is successful, ceasing transmission of the original live stream and transmitting the target live stream to the client.

2. The method according to claim 1, wherein prior to performing the timestamp alignment between the original live stream and the target live stream, the method further comprises:
pulling the original live stream from the first source and the target live stream from the second source until a preset duration threshold is exceeded, and/or until a ratio of an interval between playback timestamps of two consecutive frames of the target live stream to an interval between reception timestamps of the two consecutive frames of the target live stream is less than a preset ratio threshold.

3. The method according to claim 1, further comprising: in response to an absolute difference between timestamps of latest video frames of the original live stream and the target live stream being not less than a first preset time difference threshold, determining that the alignment fails and ceasing to pull the target live stream from the second source.

4. The method according to claim 3, wherein the performing timestamp alignment
between the original live stream and the target live stream comprises:
in response to (i) the absolute difference between timestamps of the latest video frames of the original live stream and the target live stream being not greater than a second preset time difference threshold, and (ii) a timestamp of a latest key frame of the target live stream matching a timestamp of a latest key frame of the original live stream: continuing to transmit the original live stream until pulling a next key frame of the target live stream from the second source begins and a current group of frames of the original live stream is fully transmitted, and determining that alignment is successful; and
the transmitting the target live stream to the client comprises: starting transmission of the target live stream to the client from the next key frame of the target live stream.

5. The method according to claim 4, wherein the performing timestamp alignment between the original live stream and the target live stream comprises:
in response to (i) the absolute difference between the timestamps of the latest video frames of the original live stream and the target live stream being less than the first preset time difference threshold but greater than the second preset time difference threshold, (ii) the timestamp of the latest video frame of the target live stream being greater than the timestamp of the latest video frame of the original live stream, and (iii) the timestamp of the latest key frame of the target live stream being close to the timestamp of the latest key frame of the original live stream: continuing to transmit the original live stream until pulling the next key frame of the target live stream from the second source begins and the current group of frames of the original live stream is fully transmitted, and determining that the alignment is successful; and
the transmitting the target live stream to the client comprises: starting transmission of the target live stream to the client from the next key frame of the target live stream.

6. The method according to claim 5, wherein the performing timestamp alignment between the original live stream and the target live stream comprises:
in response to (i) the absolute difference between the timestamps of the latest video frames of the original live stream and the target live stream being less than the first preset time difference threshold but greater than the second preset time difference threshold, (ii) the timestamp of the latest video frame of the target live stream being greater than the timestamp of the latest video frame of the original live stream, and (iii) the timestamp of the latest key frame of the target live stream not being close to the timestamp of the latest key frame of the original live stream: continuing to transmit the original live stream until pulling the next key frame of the original live stream from the first source begins, and determining that the alignment is successful; and
the transmitting the target live stream to the client comprises: starting transmission of the target live stream to the client from the latest key frame of the target live stream.

7. The method according to claim 6, wherein the performing timestamp alignment between the original live stream and the target live stream comprises:
in response to (i) the absolute difference between timestamps of the latest video frames of the original live stream and the target live stream being less than the first preset time difference threshold but greater than the second preset time difference threshold, and (ii) the timestamp of the latest video frame of the target live stream not being greater than the timestamp of the latest video frame of the original live stream:
reducing a transmission rate of the original live stream and continuing to transmit the original live stream until the timestamp of the latest video frame of the target live stream is greater than the timestamp of the latest video frame of the original live stream and the timestamp of the latest key frame of the target live stream matches the timestamp of the latest key frame of the original live stream, continuing to transmit the original live stream until pulling the next key frame of the target live stream from the second source begins and the current group of frames of the original live stream is fully transmitted, and determining that the alignment is successful; and
the transmitting the target live stream to the client comprises: starting transmission of the target live stream to the client from the next key frame of the target live stream.

8. An electronic device, comprising:
at least one processor; and
a memory communicatively connected to the at least one processor; wherein the memory stores instructions executable by the at least one processor, and the instructions are executed by the at least one processor to enable the at least one processor to perform operations comprising:
receiving a stream switching request from a client, wherein the switching request includes a target resolution;
pulling an original live stream from a first source and a target live stream corresponding to the target resolution from a second source, and transmitting the original live stream to the client;
performing timestamp alignment between the original live stream and the target live stream; and
in response to determining that the alignment is successful, ceasing transmission of the original live stream and transmitting the target live stream to the client.

9. The electronic device according to claim 8, wherein prior to performing the timestamp alignment between the original live stream and the target live stream, the method further comprises:
pulling the original live stream from the first source and the target live stream from the second source until a preset duration threshold is exceeded, and/or until a ratio of an interval between playback timestamps of two consecutive frames of the target live stream to an interval between reception timestamps of the two consecutive frames of the target live stream is less than a preset ratio threshold.

10. The electronic device according to claim 8, wherein the operations comprise: in response to an absolute difference between timestamps of latest video frames of the original live stream and the target live stream being not less than a first preset time difference threshold, determining that the alignment fails and ceasing to pull the target live stream from the second source.

11. The electronic device according to claim 10, wherein the performing timestamp alignment between the original live stream and the target live stream comprises:
in response to (i) the absolute difference between timestamps of the latest video frames of the original live stream and the target live stream being not greater than a second preset time difference threshold, and (ii) a timestamp of a latest key frame of the target live stream matching a timestamp of a latest key frame of the original live stream: continuing to transmit the original live stream until pulling a next key frame of the target live stream from the second source begins and a current group of frames of the original live stream is fully transmitted, and determining that alignment is successful; and
the transmitting the target live stream to the client comprises: starting transmission of the target live stream to the client from the next key frame of the target live stream.

12. The electronic device according to claim 11, wherein the performing timestamp alignment between the original live stream and the target live stream comprises:
in response to (i) the absolute difference between the timestamps of the latest video frames of the original live stream and the target live stream being less than the first preset time difference threshold but greater than the second preset time difference threshold, (ii) the timestamp of the latest video frame of the target live stream being greater than the timestamp of the latest video frame of the original live stream, and (iii) the timestamp of the latest key frame of the target live stream being close to the timestamp of the latest key frame of the original live stream: continuing to transmit the original live stream until pulling the next key frame of the target live stream from the second source begins and the current group of frames of the original live stream is fully transmitted, and determining that the alignment is successful; and
the transmitting the target live stream to the client comprises: starting transmission of the target live stream to the client from the next key frame of the target live stream.

13. The electronic device according to claim 12, wherein the performing timestamp alignment between the original live stream and the target live stream comprises:
in response to (i) the absolute difference between the timestamps of the latest video frames of the original live stream and the target live stream being less than the first preset time difference threshold but greater than the second preset time difference threshold, (ii) the timestamp of the latest video frame of the target live stream being greater than the timestamp of the latest video frame of the original live stream, and (iii) the timestamp of the latest key frame of the target live stream not being close to the timestamp of the latest key frame of the original live stream:
continuing to transmit the original live stream until pulling the next key frame of the original live stream from the first source begins, and determining that the alignment is successful; and
the transmitting the target live stream to the client comprises: starting transmission of the target live stream to the client from the latest key frame of the target live stream.

14. The electronic device according to claim 13, wherein the performing timestamp alignment between the original live stream and the target live stream comprises:
in response to (i) the absolute difference between timestamps of the latest video frames of the original live stream and the target live stream being less than the first preset time difference threshold but greater than the second preset time difference threshold, and (ii) the timestamp of the latest video frame of the target live stream not being greater than the timestamp of the latest video frame of the original live stream:
reducing a transmission rate of the original live stream and continuing to transmit the original live stream until the timestamp of the latest video frame of the target live stream is greater than the timestamp of the latest video frame of the original live stream and the timestamp of the latest key frame of the target live stream matches the timestamp of the latest key frame of the original live stream, continuing to transmit the original live stream until pulling the next key frame of the target live stream from the second source begins and the current group of frames of the original live stream is fully transmitted, and determining that the alignment is successful; and
the transmitting the target live stream to the client comprises: starting transmission of the target live stream to the client from the next key frame of the target live stream.

15. A non-transitory computer-readable storage medium storing computer instructions, wherein the computer instructions are configured to cause a computer to perform operations comprising:
receiving a stream switching request from a client, wherein the switching request includes a target resolution;
pulling an original live stream from a first source and a target live stream corresponding to the target resolution from a second source, and transmitting the original live stream to the client;
performing timestamp alignment between the original live stream and the target live stream; and
in response to determining that the alignment is successful, ceasing transmission of the original live stream and transmitting the target live stream to the client.

16. The storage medium according to claim 15, wherein prior to performing the timestamp alignment between the original live stream and the target live stream, the method further comprises:
pulling the original live stream from the first source and the target live stream from the second source until a preset duration threshold is exceeded, and/or until a ratio of an interval between playback timestamps of two consecutive frames of the target live stream to an interval between reception timestamps of the two consecutive frames of the target live stream is less than a preset ratio threshold.

17. The storage medium according to claim 15, wherein the operations comprise: in response to an absolute difference between timestamps of latest video frames of the original live stream and the target live stream being not less than a first preset time difference threshold, determining that the alignment fails and ceasing to pull the target live stream from the second source.

18. The storage medium according to claim 17, wherein the performing timestamp alignment between the original live stream and the target live stream comprises:
in response to (i) the absolute difference between timestamps of the latest video frames of the original live stream and the target live stream being not greater than a second preset time difference threshold, and (ii) a timestamp of a latest key frame of the target live stream matching a timestamp of a latest key frame of the original live stream: continuing to transmit the original live stream until pulling a next key frame of the target live stream from the second source begins and a current group of frames of the original live stream is fully transmitted, and determining that alignment is successful; and
the transmitting the target live stream to the client comprises: starting transmission of the target live stream to the client from the next key frame of the target live stream.

19. The storage medium according to claim 18, wherein the performing timestamp alignment between the original live stream and the target live stream comprises:
in response to (i) the absolute difference between the timestamps of the latest video frames of the original live stream and the target live stream being less than the first preset time difference threshold but greater than the second preset time difference threshold, (ii) the timestamp of the latest video frame of the target live stream being greater than the timestamp of the latest video frame of the original live stream, and (iii) the timestamp of the latest key frame of the target live stream being close to the timestamp of the latest key frame of the original live stream: continuing to transmit the original live stream until pulling the next key frame of the target live stream from the second source begins and the current group of frames of the original live stream is fully transmitted, and determining that the alignment is successful; and
the transmitting the target live stream to the client comprises: starting transmission of the target live stream to the client from the next key frame of the target live stream.

20. The storage medium according to claim 19, wherein the performing timestamp alignment between the original live stream and the target live stream comprises:
in response to (i) the absolute difference between the timestamps of the latest video frames of the original live stream and the target live stream being less than the first preset time difference threshold but greater than the second preset time difference threshold, (ii) the timestamp of the latest video frame of the target live stream being greater than the timestamp of the latest video frame of the original live stream, and (iii) the timestamp of the latest key frame of the target live stream not being close to the timestamp of the latest key frame of the original live stream: continuing to transmit the original live stream until pulling the next key frame of the original live stream from the first source begins, and determining that the alignment is successful; and
the transmitting the target live stream to the client comprises: starting transmission of the target live stream to the client from the latest key frame of the target live stream.
